(19) United States
(12) Patent Application Publication
(10) Pub. No.: US 2013/0333910 A1
(43) Pub. Date: Dec. 19, 2013

(54) IMPACT TOOL

(71) Applicants: Hideyuki Tanimoto, Ibaraki (JP); Nobuhiro Takano, Ibaraki (JP); Tomomasa Nishikawa, Ibaraki (JP); Kazutaka Iwata, Ibaraki (JP); Hironori Mashiko, Ibaraki (JP); Hayato Yamaguchi, Ibaraki (JP); Atsushi Nakagawa, Ibaraki (JP); Katsuhiro Oomori, Ibaraki (JP); Mizuho Nakamura, Ibaraki (JP); Hiroki Uchida, Ibaraki (JP); Saroma Nakano, Ibaraki (JP)

(72) Inventors: Hideyuki Tanimoto, Ibaraki (JP); Nobuhiro Takano, Ibaraki (JP); Tomomasa Nishikawa, Ibaraki (JP); Kazutaka Iwata, Ibaraki (JP); Hironori Mashiko, Ibaraki (JP); Hayato Yamaguchi, Ibaraki (JP); Atsushi Nakagawa, Ibaraki (JP); Katsuhiro Oomori, Ibaraki (JP); Mizuho Nakamura, Ibaraki (JP); Hiroki Uchida, Ibaraki (JP); Saroma Nakano, Ibaraki (JP)

(73) Assignee: HITACHI KOKI CO., LTD.,, Tokyo (JP)

(21) Appl. No.: 13/387,742

(22) PCT Filed: Jul. 29, 2010
(86) PCT No.: PCT/JP10/63233

§ 371 Date: Sep. 23, 2012

(30) Foreign Application Priority Data
Jul. 29, 2009 (JP) 2009-177115

(51) Int. Cl. B25B 21/02; B25B 23/147

(52) U.S. Cl. CPC B25B 21/02; B25B 23/1475
USPC 173/176; 173/47; 173/48; 173/2

(57) ABSTRACT

According to one embodiment, an impact tool includes: a motor; and a hammer that is connected to the motor and that has a striking-side surface; and an anvil that is journalled to be rotatable with respect to the hammer, that has a struck-side surface and that provides a striking power to a tip tool, wherein the motor is drivable in: a first driving mode in which the motor is continuously driven in a normal rotation; a second driving mode in which the motor is intermittently driven only in the normal rotation; and a third driving mode in which the motor is intermittently driven in the normal rotation and in a reverse rotation.

### TECHNICAL FIELD

An aspect of the present invention relates to an impact tool which is driven by a motor and realizes a new striking mechanism.

### BACKGROUND ART

In an impact tool, a rotation striking mechanism is driven by a motor as a driving source to provide rotation and striking to an anvil, thereby intermittently transmitting rotation striking power to a tip tool for performing operation, such as screwing. As a motor, a brushless DC motor is widely used. The brushless DC motor is, for example, a DC (direct current) motor with no brush (brush for commutation). Coils (windings) are used on the stator side, magnets (permanent magnets) are used on the rotor side, and a rotor is rotated as the electric power driven by an inverter circuit is sequentially applied to predetermined coils. The inverter circuit is constructed using an FET (field effect transistor), and a high-capacity output transistor such as an IGBT (insulated gate bipolar transistor), and is driven by a large current. The brushless DC motor has excellent torque characteristics as compared with a DC motor with a brush, and is able to fasten a screw, a bolt, etc. to a base member with a stronger force.

JP-2009-072888-A discloses an impact tool using the brushless DC motor. In JP-2009-072888-A, the impact tool has a continuous rotation type impact mechanism. When torque is given to a spindle via a power transmission mechanism (speed-reduction mechanism), a hammer which movably engages in the direction of a rotary shaft of the spindle rotates, and an anvil which abuts on the hammer is rotated. The hammer and the anvil have two hammer convex portions (striking portions) which are respectively arranged symmetrically to each other at two places on a rotation plane, these convex portions are at positions where the gears mesh with each other in a rotation direction, and rotation striking power is transmitted by meshing between the convex portions. The hammer is made axially slidable with respect to the spindle in a ring region surrounding the spindle, and an inner peripheral surface of the hammer includes an inverted V-shaped (substantially triangular) cam groove. A V-shaped cam groove is axially provided in an outer peripheral surface of the spindle, and the hammer rotates via balls (steel balls) inserted between the cam groove and the inner peripheral cam groove of the hammer.

In the conventional power transmission mechanism, the spindle and the hammer are held via the balls arranged in the cam groove, and the hammer is constructed so as to be able to retreat axially rearward with respect to the spindle by the spring arranged at the rear end thereof. As a result, the number of parts of the spindle and the hammer increases, high attaching accuracy between the spindle and the hammer is required, thereby increasing the manufacturing cost.

Meanwhile, in the impact tool of the conventional technique, in order to perform a control so as not to operate the impact mechanism (that is, in order that striking does not occur), for example, a mechanism for controlling a retreat operation of the hammer is required. The impact tool of JP-2009-072888-A cannot be used in a so-called drill mode. Further, even if a drill mode is realized (even if a retreat operation of the hammer is controlled), in order to realize even the clutch operation of interrupting power transmission when a given fastening torque is achieved, it is necessary to provide a clutch mechanism separately, and realizing the drill mode and the drill mode with a clutch in the impact tool leads to cost increase.

Further, in JP-2009-072888-A, the driving electric power to be supplied to the motor is constant irrespective of the load state of a tip tool during the striking by the hammer. Accordingly, striking is performed with a high fastening torque even in the state of light load. As a result, excessive electric power is supplied to the motor, and useless power consumption occurs. And, a so-called coming-out phenomenon occurs where a screw advances excessively during screwing as striking is performed with a high fastening torque, and the tip tool is separated from a screw head.

### SUMMARY OF INVENTION

One object of the invention is to provide an impact tool in which an impact mechanism is realized by a hammer and an anvil with a simple mechanism.

Another object of the invention is to provide an impact tool which can drive a hammer and an anvil between which the relative rotation angle is less than 360 degrees, thereby performing a fastening operation, by devising a driving method of a motor.

Still another object of the invention is to provide a multi-use impact tool which can switch and be used in a drill mode and impact mode.

According to a first aspect of the present invention, there is provided an impact tool including: a motor; and a hammer that is connected to the motor and that has a striking-side surface; and an anvil that is journalled to be rotatable with respect to the hammer, that has a struck-side surface and that provides a striking power to a tip tool, wherein the motor is drivable in: a first driving mode in which the motor is continuously driven in a normal rotation; a second driving mode in which the motor is intermittently driven only in the normal rotation; and a third driving mode in which the motor is intermittently driven in the normal rotation and in a reverse rotation.

According to a second aspect of the present invention, there may be provided the impact tool, wherein the impact tool is operable in: a drill mode in which the motor is driven in the first mode; and an impact mode in which the motor is driven in at least two of the first to third driving modes while switching therebetween.

According to a third aspect of the present invention, there may be provided the impact tool, further including: an inverter circuit that supplies a given driving current to the motor; and a control unit that controls the inverter circuit to thereby control a rotation direction and a rotating speed of the motor so that the first to third driving modes are performed.

According to a fourth aspect of the present invention, there may be provided the impact tool, wherein the second driving mode and the third driving mode are performed by a pulse control of the inverter circuit.

According to a fifth aspect of the present invention, there may be provided the impact tool, wherein, in the impact mode, the motor is driven in the first driving mode when a load is light, and the motor is driven in the second driving mode when the load becomes heavy.

According to a sixth aspect of the present invention, there may be provided the impact tool, wherein, in the impact mode, the motor is driven in the third mode when the load further becomes heavier in a state where the motor is driven in the second mode.

According to a seventh aspect of the present invention, there may be provided the impact tool, wherein the control unit shifts the motor between the first to third driving modes based on: a value of a current flowing into the motor; a change in the rotating speed of the motor; or a value of an impact torque generated at an output shaft of the anvil.

According to an eighth aspect of the present invention, there may be provided the impact tool, wherein, in the third driving mode, the motor is reversely rotated until reaching a given reverse rotating speed.

According to a ninth aspect of the present invention, there may be provided the impact tool, further including: a current detecting circuit that detects a current flowing into the motor, wherein, in the drill mode, the control unit stops the motor when a value of the detected current becomes equal to or higher than a given threshold value.

According to a tenth aspect of the present invention, there may be provided the impact tool, further including: a switching dial that allows the user: to switch between the drill mode and the impact mode and to set, within the drill mode, plural stages of torque values for stopping a rotation of the motor.

According to an eleventh aspect of the present invention, there is provided an impact tool including: a motor; and a hammer that is connected to the motor and that has a striking-side surface; and an anvil that is journalled to be rotatable with respect to the hammer, that has a struck-side surface and that provides a striking power to a tip tool, wherein the motor is drivable in: a first intermittent driving mode; and a second intermittent driving mode different from the first intermittent driving mode.

According to a twelfth aspect of the present invention, there may be provided the impact tool, wherein, in the first intermittent driving mode, the motor is intermittently rotated only in a normal rotation, wherein, in the second intermittent driving mode, the motor is intermittently rotated in the normal rotation and in a reverse rotation, and wherein the motor is switchable from the first intermittent driving mode to the second intermittent driving mode.

According to a thirteenth aspect of the present invention, there may be provided the impact tool, wherein the motor is switchable from the first intermittent driving mode to the second intermittent driving mode during one fastening operation.

According to a fourteenth aspect of the present invention, there may be provided the impact tool, wherein the striking power of the hammer to the anvil in the first intermittent driving mode is smaller than the striking power of the hammer to the anvil in the second intermittent driving mode.

According to a fifteenth aspect of the present invention, there may be provided the impact tool, wherein a striking speed of the hammer in the first intermittent driving mode is smaller than the striking speed of the hammer in the second intermittent driving mode.

According to a sixteenth aspect of the present invention, there may be provided the impact tool, wherein a rotating speed of the hammer in the first intermittent driving mode is smaller than the rotating speed of the hammer in the second intermittent driving mode.

According to a seventeenth aspect of the present invention, there may be provided the impact tool, further including: an inverter circuit that supplies a given driving current to the motor; and a control unit that controls so that a supply time, an amplitude, or effective value of a driving pulse to be supplied to the inverter circuit for the normal ration of the motor in the first intermittent driving mode is smaller than these in the second intermittent driving mode.

According to the first aspect of the invention, since fastening is performed by driving the motor in three modes including continuous driving of normal rotation, intermittent driving of only normal rotation, and intermittent driving of normal rotation and reverse rotation, the anvil and the hammer can be made into a simple construction, and the hammer does not need to be continuously rotated relative to the anvil. Thus, there is no need for providing a conventional cam mechanism, a mechanism which retreats axially, a spring, or the like, and it is possible to realize a compact striking mechanism in which axial front-rear length is made short.

According to the second aspect of the invention, since the impact tool is operable in the drill mode and in the impact mode, it is possible to realize a so-called multi-tool which has realized two modes of the drill mode and the impact mode.

According to the third aspect of the invention, since the control unit which controls the inverter circuit controls the rotation direction and rotating speed of the motor, it is possible to easily realize three driving modes by electronic control.

According to the fourth aspect of the invention, since the intermittent driving mode of the motor is performed by controlling the pulse of the inverter circuit, it is possible to realize the striking effect that the hammer strikes the anvil.

According to the fifth aspect of the invention, in the impact mode, fastening is performed in the continuous driving mode while load is light, and fastening is performed in the intermittent driving mode if load becomes heavy. Thus, it is possible to perform a fastening operation efficiently and rapidly.

According to the sixth aspect of the invention, since fastening is performed by switching to the intermittent driving mode which repeats the normal rotation and reverse rotation of the motor if load further becomes heavier in the intermittent driving mode of only the normal rotation, a fastening subject member can be fastened with a higher fastening torque.

According to the seventh aspect of the invention, since the control unit performs shifting of the driving mode, using the value of a current which flows into the motor, a change in rotating speed of the motor, or the value of impact torque generated at an output shaft of the striking mechanism, switching of the driving mode can be realized using the existing elements, without providing new elements or instruments for shifting of the driving mode, and cost increase can be suppressed.

According to the eighth aspect of the invention, since the motor is reversed until a given reverse rotating speed is reached in the intermittent driving mode of the normal rotation and reverse rotation, the hammer can be rotated in the normal rotation direction after being sufficiently rotated in the reverse direction, and the anvil can be struck with sufficient energy. Thus, a high fastening torque can be achieved.

According to the ninth aspect of the invention, since a current detecting circuit is provided, and the control unit stops the motor in the drill mode if the value of the detected current becomes equal to or higher than a given threshold value, a clutch mechanism can be electronically realized even if a mechanical clutch mechanism is not provided.

According to the tenth aspect of the invention, since a switching dial is provided to switch the drill mode and the impact mode, and plural stages of setting positions for setting a torque value which stops the rotation of the motor is provided in the switching dial in the drill mode, the switching of the modes and the setting of the torque value of a clutch mechanism can be performed by one dial.

According to the eleventh aspect of the invention, since fastening is performed using a first intermittent driving mode, and a second intermittent driving mode different in control from the first intermittent driving mode, as control modes of the motor, it is possible to cope with fastening to plural fastening subject members (mating members).

According to the twelfth aspect of the invention, since switching from the first intermittence driving mode of only normal rotation to the second intermittent driving mode which performs intermittent driving of normal rotation and reverse rotation is performed, a fastening operation can be performed in a driving mode which is optimal for a required fastening torque value.

According to the thirteenth aspect of the invention, since switching to the second intermittent driving mode from the first intermittent driving mode is performed during one fastening operation, fastening torque for a fastening subject member (mating member) can be gradually increased, and favorable fastening can be performed.

According to the fourteenth aspect of the invention, since the striking power of the hammer to the anvil in the first intermittent driving mode is smaller than the striking power of the hammer to the anvil in the second intermittent driving mode, it is possible to perform a fastening operation with a small torque in an early stage of fastening.

According to the fifteenth aspect of the invention, since the striking speed of the hammer in the first intermittent driving mode is smaller than the striking speed of the hammer in the second intermittent driving mode, striking can be performed at high speed in the case of low load.

According to the sixteenth aspect of the invention, since the rotating speed of the hammer in the first intermittent driving mode is smaller than the rotating speed of the hammer in the second intermittent driving mode, striking can be performed with small striking power.

According to the seventeenth aspect of the invention, since the supply time, amplitude, or effective value of a driving pulse to be supplied to the inverter circuit for normally rotating the motor is smaller in the first intermittent driving mode than in the second intermittent driving mode, striking can be performed with small striking power.

The above and other objects and new features of the invention will be apparent from the following description of the specification and the drawings.

### BRIEF DESCRIPTION OF DRAWINGS

FIG. 1 cross-sectionally illustrates an impact tool 1 related to an embodiment.

FIG. 2 illustrates an appearance of the impact tool 1 related to the embodiment.

FIG. 3 enlargedly illustrates around a striking mechanism 40 of FIG. 1.

FIG. 4 illustrates a cooling fan 18 of FIG. 1.

FIG. 5 illustrates a functional block diagram of a motor driving control system of the impact tool related to the embodiment.

FIG. 6 illustrates a hammer 151 and an anvil 156 related to a basic construction (second embodiment) of the invention.

FIG. 7 illustrates the striking operation of the hammer 151 and the anvil 156 of FIG. 6, in six stages.

FIG. 8 illustrates the hammer 41 and the anvil 46 of FIG. 1.

FIG. 9 illustrates a hammer 41 and an anvil 46 of FIG. 1 as viewed from a different angle.

FIG. 10 illustrates the striking operation of the hammer 41 and the anvil 46 shown in FIGS. 8 and 9.

FIG. 11 illustrates a trigger signal during the operation of the impact tool 1, a driving signal of an inverter circuit, the rotating speed of the motor 3, and the striking state of the hammer 41 and the anvil 46.

FIG. 12 illustrates a driving control procedure of the motor 3 related to the embodiment.

FIG. 13 illustrates graphs showing a current to be applied to the motor and the rotation number in a pulse mode (1) and a pulse mode (2).

FIG. 14 illustrates the driving control procedure of the motor in a pulse mode (1) related to the embodiment.

FIG. 15 illustrates the relationship between the rotation number of the motor 3 and elapsed time and the relationship between the value of a current to be supplied to the motor 3 and elapsed time.

FIG. 16 illustrates the driving control procedure of the motor 3 in the pulse mode (2) related to the embodiment.

### DESCRIPTION OF EMBODIMENTS

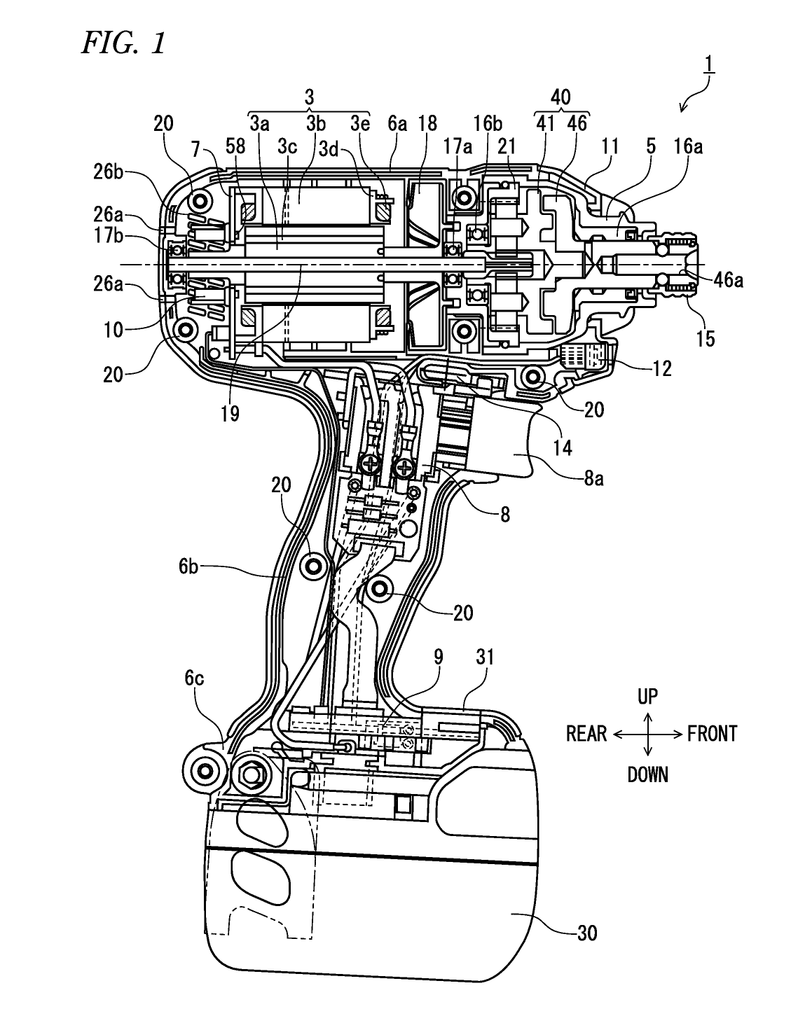

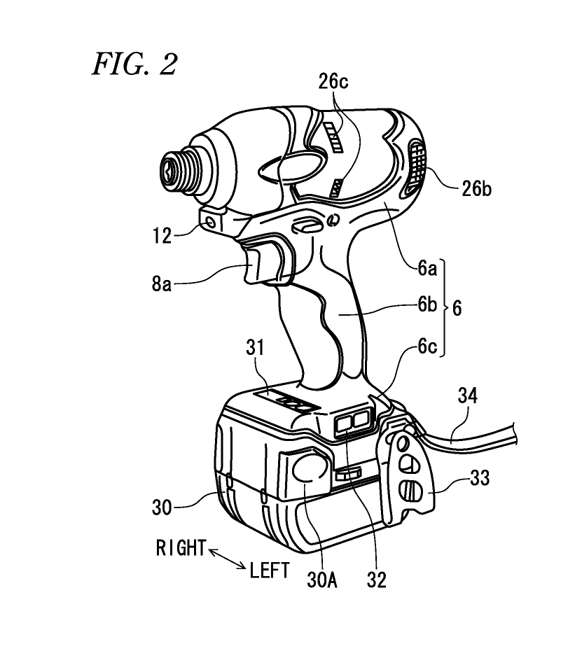

Hereinafter, embodiments will be described with reference to the drawings. In the following description, the directions of up and down, front and rear, and right and left correspond to the directions shown in FIGS. 1 and 2.

FIG. 1 illustrates an impact tool 1 according to one embodiment. The impact tool 1 drives the striking mechanism 40 with a chargeable battery pack 30 as a power source and a motor 3 as a driving source, and gives rotation and striking to the anvil 46 as an output shaft to transmit continuous torque or intermittent striking power to a tip tool (not shown), such as a driver bit, thereby performing an operation, such as screwing or bolting.

The motor 3 is a brushless DC motor, and is accommodated in a tubular trunk portion 6a of a housing 6 which has a substantial T-shape as seen from the side. The housing 6 is splittable into two substantially-symmetrical right and left members, and the right and left members are fixed by plural screws. For example, one (the left member in the embodiment) of the right and left members of the housing 6 is formed with plural screw bosses 20, and the other (the right member in the embodiment) is formed with plural screw holes (not shown). In the trunk portion 6a, the rotary shaft 19 of the motor 3 is rotatably held by bearings 17b at the rear end, and bearings 17a provided around the central portion. Aboard on which six switching elements 10 are loaded is provided at the rear of the motor 3, and the motor 3 is rotated by inverter-controlling these switching elements 10. A rotational position detecting element 58, such as a Hall element or a Hall IC, are loaded at the front of the board 7 to detect the position of the rotor 3a.

In the housing 6, a grip portion 6b extends almost perpendicularly and integrally from the trunk portion 6a. A trigger switch 8 and a normal/reverse switching lever 14 are provided at an upper portion in the grip portion 6b. A trigger operating portion 8a of the trigger switch 8 is urged by a spring (not shown) to protrude from the grip portion 6b. A control circuit board 9 for controlling the speed of the motor 3 through the trigger operating portion 8a is accommodated in a lower portion in the grip portion 6b. A battery holding portion 6c is formed in the lower portion of the grip portion 6b, and a battery pack 30 including plural nickel hydrogen or lithium ion battery cells is detachably mounted on the battery holding portion 6c.

A cooling fan 18 is attached to the rotary shaft 19 at the front of the motor 3 to synchronizedly rotate therewith. The cooling fan 18 sucks air through air inlets 26a and 26b provided at the rear of the trunk portion 6a. The sucked air is discharged outside the housing 6 from plural slits 26c (refer to FIG. 2) formed around the radial outer peripheral side of the cooling fan 18 in the trunk portion 6a.

The striking mechanism 40 includes the anvil 46 and the hammer 41. The hammer 41 is fixed so as to connect rotary shafts of plural planetary gears of the planetary gear speed-reduction mechanism 21. Unlike a conventional impact mechanism which is now widely used, the hammer 41 does not have a cam mechanism which has a spindle, a spring, a cam groove, balls, etc. The anvil 46 and the hammer 41 are connected with each other by a fitting shaft 41a and a fitting groove 46f formed around rotation centers thereof so that only less than one relative rotation can be performed therebetween. At a front end of the anvil 46, an output shaft portion to mount a tip tool (not shown) and a mounting hole 46a having a hexagonal cross-sectional shape in an axial direction are integrally formed. The rear side of the anvil 46 is connected to the fitting shaft 41a of the hammer 41, and is held around the axial center by a metal bearing 16a so as to be rotatable with respect to a case 5. The detailed shape of the anvil 46 and the hammer 41 will be described later.

The case 5 is integrally formed from metal for accommodating the striking mechanism 40 and the planetary gear speed-reduction mechanism 21, and is mounted on the front side of the housing 6. The outer peripheral side of the case 5 is covered with a cover 11 made of resin in order to prevent a heat transfer, and an impact absorption, etc. The tip of the anvil 46 includes a sleeve 15 and balls 24 for detachably attaching the tip tool. The sleeve 15 includes a spring 15a, a washer 15b and a retaining ring 15c.

When the trigger operating portion 8a is pulled and the motor 3 is started, the rotational speed of the motor 3 is reduced by the planetary gear speed-reduction mechanism 21, and the hammer 41 rotates at a rotation number with a given reduction ratio with respect to the rotation number of the motor 3. When the hammer 41 rotates, the torque thereof is transmitted to the anvil 46, and the anvil 46 starts rotation at the same speed as the hammer 41. When the force applied to the anvil 46 becomes large by a reaction force received from the tip tool side, a control unit detects an increase in fastening reaction force, and drives the hammer 41 continuously or intermittently while changing the driving mode of the hammer 41 before the rotation of the motor 3 is stopped (the motor 3 is locked).

FIG. 2 illustrates the appearance of the impact tool 1 of FIG. 1. The housing 6 includes three portions 6a, 6b, and 6c, and slits 26c for discharge of cooling air is formed around the radial outer peripheral side of the cooling fan 18 in the trunk portion 6a. A control panel 31 is provided on the upper face of the battery holding portion 6c. Various operation buttons, indicating lamps, etc. are arranged at the control panel 31, for example, a switch for turning on/off an LED light 12, and a button for confirming the residual amount of the battery pack are arranged on the control panel 31. A toggle switch 32 for switching the driving mode (the drill mode and the impact mode) of the motor 3 is provided on a side face of the battery holding portion 6c, for example. Whenever the toggle switch 32 is depressed, the drill mode and the impact mode are alternately switched.

The battery pack 30 includes release buttons 30A located on both right and left sides thereof, and the battery pack 30 can be detached from the battery holding portion 6c by moving the battery pack 30 forward while pushing the release buttons 30A. A metallic belt hook 33 is detachably attached to one of the right and left sides of the battery holding portion 6c. Although the belt hook 33 is attached at the left side of the impact tool 1 in FIG. 2, the belt hook 33 can be detached therefrom and attached to the right side. A strap 34 is attached around a rear end of the battery holding portion 6c.

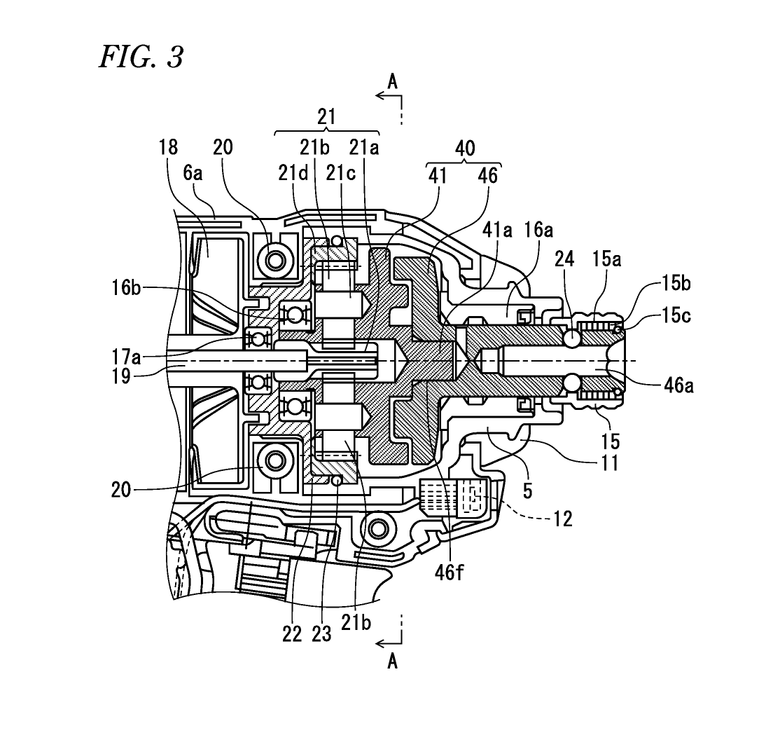

FIG. 3 enlargedly illustrates around a striking mechanism 40 of FIG. 1. The planetary gear speed-reduction mechanism 21 is a planetary type. A sun gear 21a connected to the tip of the rotary shaft 19 of the motor 3 functions as a driving shaft (input shaft), and plural planetary gears 21b rotate within an outer gear 21d fixed to the trunk portion 6a. Plural rotary shafts 21c of the planetary gears 21b is held by the hammer 41 as a planetary carrier. The hammer 41 rotates at a given reduction ratio in the same direction as the motor 3, as a driven shaft (output shaft) of the planetary gear speed-reduction mechanism 21. This reduction ratio is set based on factors, such as a fastening subject (a screw or a bolt) and the output of the motor 3 and the required fastening torque. In the present embodiment, the reduction ratio is set so that the rotation number of the hammer 41 becomes about ⅛ to 1/15 of the rotation number of the motor 3.

An inner cover 22 is provided on the inner peripheral side of two screw bosses 20 inside the trunk portion 6a. The inner cover 22 is manufactured by integral molding of synthetic resin, such as plastic. A cylindrical portion is formed on the rear side of the inner cover, and bearings 17a which rotatably fixes the rotary shaft 19 of the motor 3 are held by a cylindrical portion of the inner cover. A cylindrical stepped portion which has two different diameters is provided on the front side of the inner cover 22. Ball-type bearings 16b are provided at the stepped portion with a smaller diameter, and a portion of an outer gear 21d is inserted from the front side at the cylindrical stepped portion with a larger diameter. Since the outer gear 21d is non-rotatably attached to the inner cover 22, and the inner cover 22 is non-rotatably attached to the trunk portion 6a of the housing 6, the outer gear 21d is fixed in a non-rotating state. An outer peripheral portion of the outer gear 21d includes a flange portion with a largely formed external diameter, and an O ring 23 is provided between the flange portion and the inner cover 22. Grease (not shown) is applied to rotating portions of the hammer 41 and the anvil 46, and the O ring 23 performs sealing so that the grease does not leak into the inner cover 22 side.

In the present embodiment, a hammer 41 functions as a planetary carrier which holds the plural rotary shafts 21c of the planetary gear 21b. Therefore, the rear end of the hammer 41 extends to the inner peripheral side of the bearings 16b. The rear inner peripheral portion of the hammer 41 is arranged in a cylindrical inner space which accommodates the sun gear 21a attached to the rotary shaft 19 of the motor 3. A fitting shaft 41a which protrudes axially forward is formed around the front central axis of the hammer 41, and the fitting shaft 41a fits to a cylindrical fitting groove 46f formed around the rear central axis of the anvil 46. The fitting shaft 41a and the fitting groove 46f are journalled so that both are rotatable relative to each other.

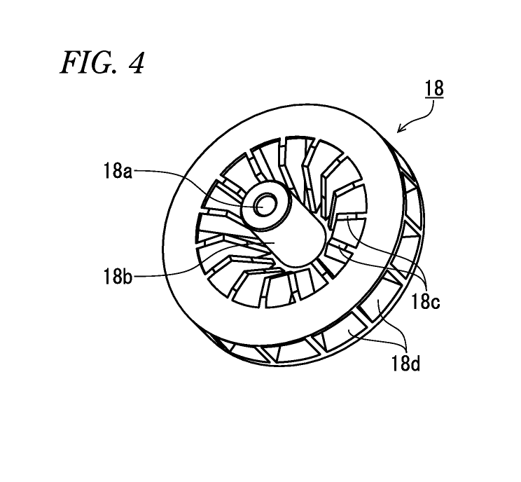

FIG. 4 illustrates the cooling fan 18. The cooling fan 18 is manufactured by integral molding of synthetic resin, such as plastic. The rotation center of the cooling fan is formed with a through hole 18a which the rotary shaft 19 passes through, a cylindrical portion 18b which secures a given distance from a rotor 3a which covers the rotary shaft 19 by a given distance in the axial direction is formed, and plural fins 18c is formed on an outer peripheral side from the cylindrical portion 18b. An annular portion is provided on the front and rear sides of each fin 18c, and the air sucked from the axial rear side (not only the rotation direction of the cooling fan 18) is discharged outward in the circumferential direction from plural openings 18d formed around the outer periphery of the cooling fan. Since the cooling fan 18 exhibits the function of a so-called centrifugal fan, and is directly connected to the rotary shaft 19 of the motor 3 without going through the planetary gear speed-reduction mechanism. 21, and rotates with a sufficiently larger rotation number than the hammer 41, sufficient air volume can be secured.

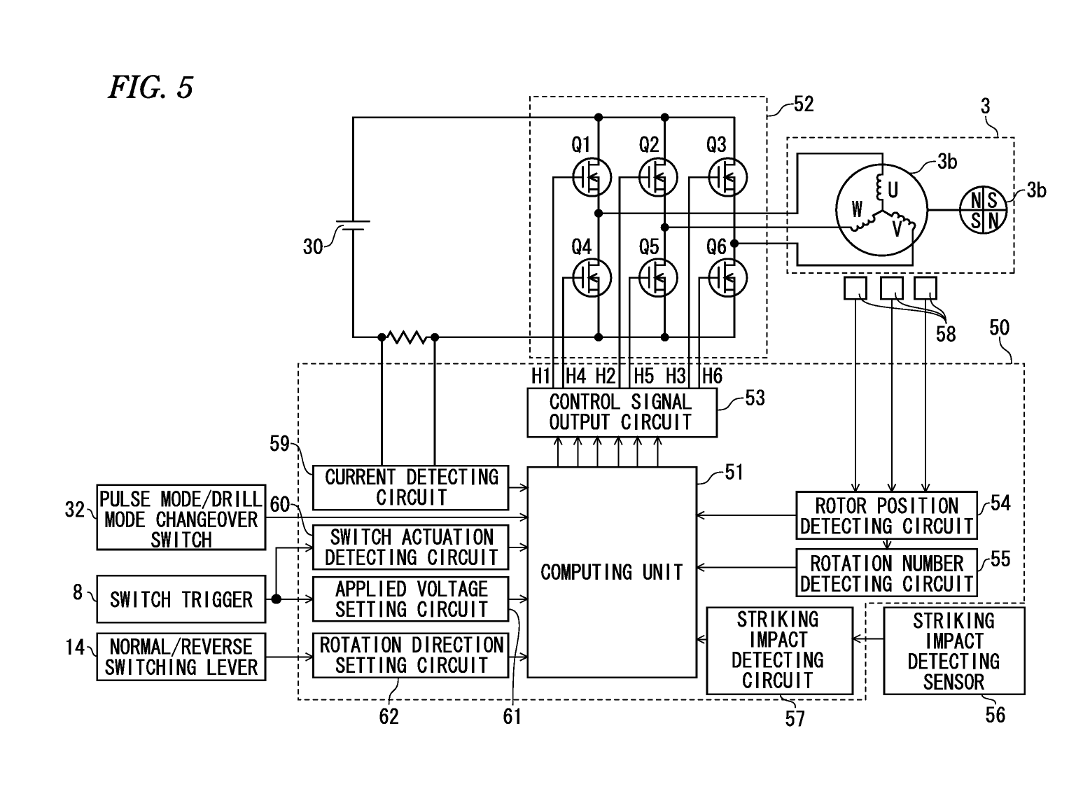

Next, the construction and operation of the motor driving control system will be described with reference to FIG. 5. FIG. 5 illustrates the motor driving control system. In the present embodiment, the motor 3 includes a three-phase brushless DC motor. This brushless DC motor is a so-called inner rotor type, and has a rotor 3a including permanent magnets (magnets) including plural (two, in the embodiment) N-S poles sets, a stator 3b composed of three-phase stator windings U, V, and W which are wired as a stator, and three rotational position detecting elements (Hall elements) 58 arranged at given intervals, for example, at 60 degrees in the peripheral direction in order to detect the rotational position of the rotor 3a. Based on position detection signals from the rotational position detecting elements 58, the energizing direction and time to the stator windings U, V, and W are controlled, thereby rotating the motor 3. The rotational position detecting elements 58 are provided at positions which face the permanent magnets 3c of the rotor 3a on the board 7.

Electronic elements to be loaded on the board 7 include six switching elements Q1 to Q6, such as FET, which are connected as a three-phase bridge. Respective gates of the bridge-connected six switching elements Q1 to Q6 are connected to a control signal output circuit 53 loaded on the control circuit board 9, and respective drains/sources of the six switching elements Q1 to Q6 are connected to the stator windings U, V, and W which are wired as a stator. Thereby, the six switching elements Q1 to Q6 perform switching operations by switching element driving signals (driving signals, such as H4, H5, and H6) input from the control signal output circuit 53, and supplies electric power to the stator windings U, V, and W with the direct current voltage of the battery pack 30 to be applied to the inverter circuit 52 as three-phase voltages (U phase, V phase, and W phase) Vu, Vv, and Vw.

Among switching elements driving signals (three-phase signals which drive the respective signals of the six switching elements Q1 to Q6, driving signals for the three negative power supply side switching element Q4, Q5, and Q6 are supplied as pulse width modulation signals (PWM signals) H4, H5, and H6, and the pulse width (duty ratio) of the PWM signals is changed by the computing unit 51 loaded on the control circuit board 9 based on a detection signal of the operation amount (stroke) of the trigger operating portion 8a of the trigger switch 8, whereby the power supply amount to the motor 3 is adjusted, and the start/stop and rotating speed of the motor 3 are controlled.

PWM signals are supplied to either the positive power supply side switching elements Q1 to Q3 or the negative power supply side switching elements Q4 to Q6 of the inverter circuit 52, and the electric power to be supplied to stator windings U, V, and W from the direct current voltage of the battery pack 30 is controlled by switching the switching elements Q1 to Q3 or the switching elements Q4 to Q6 at high speed. In the present embodiment, PWM signals are supplied to the negative power supply side switching elements Q4 to Q6. Therefore, the rotating speed of the motor 3 can be controlled by controlling the pulse width of the PWM signals, thereby adjusting the electric power to be supplied to each of the stator windings U, V, and W.

The impact tool 1 includes the normal/reverse switching lever 14 for switching the rotation direction of the motor 3. Whenever a rotation direction setting circuit 62 detects the change of the normal/reverse switching lever 14, the control signal to switch the rotation direction of the motor is transmitted to a computing unit 51. The computing unit 51 includes a central processing unit (CPU) for outputting a driving signal based on a processing program and data, a ROM for storing a processing program or control data, and a RAM for temporarily storing data, a timer, etc., although not shown.

The control signal output circuit 53 forms a driving signal for alternately switching predetermined switching elements Q1 to Q6 based on output signals of the rotation direction setting circuit 62 and a rotor position detecting circuit 54, and outputs the driving signal to the control signal output circuit 53. This alternately energizes a predetermined winding wire of the stator windings U, V, and W, and rotates the rotor 3a in a set rotation direction. In this case, driving signals to be applied to the negative power supply side switching elements Q4 to Q6 are output as PWM modulating signals based on an output control signal of an applied voltage setting circuit 61. The value of a current to be supplied to the motor 3 is measured by the current detecting circuit 59, and is adjusted into a set driving electric power as the value of the current is fed back to the computing unit 51. The PWM signals may be applied to the positive power supply side switching elements Q1 to Q3.

A striking impact sensor 56 which detects the magnitude of the impact generated in the anvil 46 is connected to the control unit 50 loaded on the control circuit board 9, and the output thereof is input to the computing unit 51 via the striking impact detecting circuit 57. The striking impact sensor 56 can be realized by a strain gauge, etc. attached to the anvil 46, and when fastening is completed with normal torque by using the output of the striking impact sensor 56, the motor 3 may be automatically stopped.

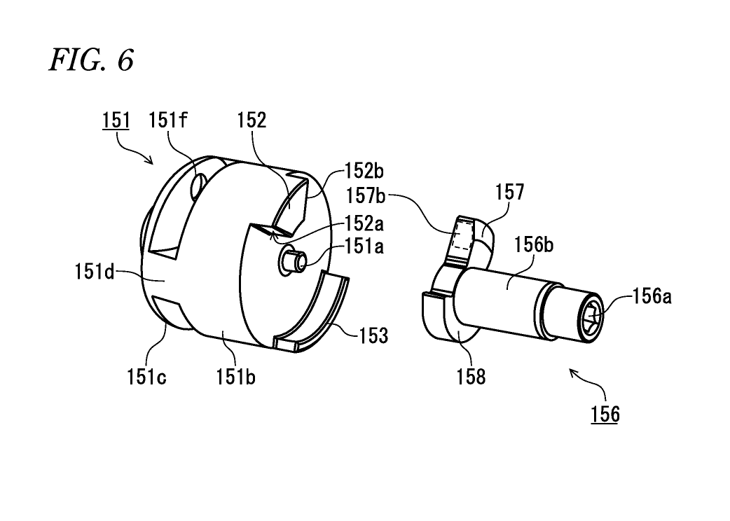

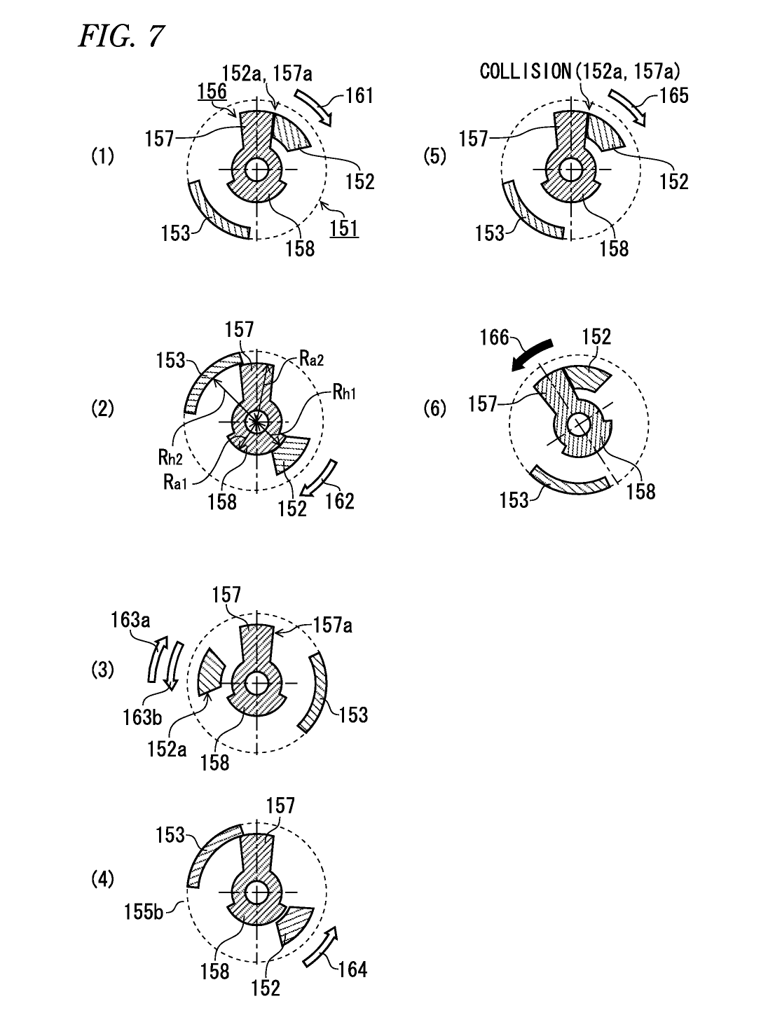

Next, before the striking operation of the hammer 41 and the anvil 46 related to the present embodiment is described, the basic construction of the hammer and the anvil and the striking operation principle thereof will be described with reference to FIGS. 6 and 7. FIG. 6 illustrates the hammer 151 and the anvil 156 related to a basic construction (a second embodiment). The hammer 151 is formed with a set of protruding portions, i.e., a protruding portion 152 and a protruding portion 153 which protrude axially from the cylindrical main body portion 151b. The front center of the main body portion 151b is formed with a fitting shaft 151a which fits to a fitting groove (not shown) formed at the rear of the anvil 156, and the hammer 151 and the anvil 156 are connected together so as to be rotatable relative to each other by a given angle of less than one rotation (less than 360 degrees). The protruding portion 152 acts as a striking pawl, and has planar striking-side surfaces 152a and 152b formed on both sides in a circumferential direction. The hammer 151 further includes a protruding portion 153 for maintaining rotation balance with the protruding portion 152. Since the protruding portion 153 functions as a weight portion for taking rotation balance, no striking-side surface is formed.

A disc portion 151c is formed on the rear side of the main body portion 151b via a connecting portion 151d. The space between the main body portion 151b and the disc portion 151d is provided to arrange the planetary gear 21b of the planetary gear mechanism 21, and the disc portion 151d is formed with a through hole 151f for holding the rotary shafts 21c of the planetary gear 21b. Although not shown, a holding hole for holding the rotary shafts 21c of the planetary gear 21b is formed also on the side of the main body portion 151b which faces disc portion 151d.

The anvil 156 is formed with a mounting hole 156a for mounting the tip tool on the front end side of the cylindrical main body portion 156b, and two protruding portions 157 and 158 which protrude radially outward from the main body portion 156b are formed on the rear side of the main body portion 156b. The protruding portion 157 is a striking pawl which has struck-side surfaces 157a and 157b, and is a weight portion in which a protruding portion 158 does not have a struck-side surface. Since the protruding portion 157 is adapted to collide with the protruding portion 152, the external diameter thereof is made equal to the external diameter of the protruding portion 152. Both the protruding portions 153 and 158 only acting as a weight are formed to not interfere with each other and not to collide with any part. In order to take the rotation angle between the hammer 151 and the anvil 156 as much as possible (less than one rotation at the maximum), the radial thicknesses of the protruding portions 153 and 158 are made small to increase a circumferential length so that the rotation balance between the protruding portions 152 and 157 is maintained. By setting the relative rotation angle greatly, a large acceleration section (run-up section) of the hammer when the hammer is made to collide with the anvil can be taken, and striking can be performed with considerable energy.

FIG. 7 illustrates one rotation movement in the usage state of the hammer 151 and the anvil 156 in six stages. The sectional plane of FIG. 7 is vertical to the axial direction, and includes a striking-side surface 152a (FIG. 6). In the state of FIG. 7(1), while fastening torque received from the tip tool is small, the anvil 156 rotates counterclockwise by being pushed from the hammer 151. However, when the fastening torque becomes large, and rotation becomes impossible only by the pushing force from the hammer 151, since the anvil 156 is struck by the hammer 151, the reverse rotation of the motor 3 is started in order to reversely rotate the hammer 151 in the direction of arrow 161. By starting the reverse rotation of the motor 3 in a state shown in (1), thereby rotating the protruding portion 152 of the hammer 151 in the direction of arrow 161, and further reversely rotate the motor 3, the protruding portion 152 rotates while being accelerated in the direction of arrow 162 through the outer peripheral side of the protruding portion 158 as shown in (2). Similarly, the external diameter Rₐ₁ of the protruding portion 158 is made smaller than the internal diameter Rₕ₁ of the protruding portion 152, and thus both the protruding portions do not collide with each other. The external diameter Rₐ₂ of the protruding portion 157 is made smaller than the internal diameter Rₕ₂ of the protruding portion 153, and thus both the protruding portions do not collide with each other. If the protruding portions are constructed in such positional relationship, the relative rotation angle of the hammer 151 and the anvil 156 can be made greater than 180 degrees, and the sufficient reverse rotation angle of the hammer 151 with respect to the anvil 156 can be secured.

When the hammer 151 further reversely rotates, and arrives at a position (stop position of the reverse rotation) of FIG. 7(3) as shown by arrow 163a, the rotation of the motor 3 is paused for a given time period, and then, the rotation of the motor 3 in the direction of arrow 163b (the normal rotation direction) is started. When the hammer 151 is reversely rotated, it is important to stop the hammer 151 reliably at a stop position so as not to collide with the anvil 156. Although the stop position of the hammer 151 before a position where the hammer collides with the anvil 156 is arbitrary set, it is desirable to make the stop position as large as possible according to the required fastening torque. It is not necessary to set the stop position to the same position each time, and the reverse rotation angle may be made small in an initial stage of fastening, and the reverse rotation angle may be set large as fastening proceeds. If the stop position is made variable in this way, since the time required for reverse rotation can be set to the minimum, striking operation can be rapidly performed in a short time.

Then, the hammer 151 is further accelerated while pas sing through the position of FIG. 7(4) in the direction of arrow 164, and the striking-side surface 152a of the protruding portion 152 collides with the struck-side surface 157a of the anvil 156 at a position shown in FIG. 7(5) in a state under acceleration. As a result of this collision, powerful rotation torque is transmitted to the anvil 156, and the anvil 156 rotates in the direction shown by arrow 166. The position of FIG. 7(6) is a state where both the hammer 151 and the anvil 156 have rotated at a given angle from the state of FIG. 7(1), and a fastening subject member is fastened to a proper torque by repeating the operation from the state shown in FIG. 7(1) to FIG. 7(5) again.

As described above, in the hammer 151 and the anvil 156 related to the second embodiment, an impact tool can be realized with a simple construction of the hammer 151 and the anvil 156 serving as a striking mechanism by using a driving mode where the motor 3 is reversely rotated. In the striking mechanism of this construction, the motor can also be rotated in the drill mode by the setting of the driving mode of the motor 3. For example, in the drill mode, it is possible to rotate the hammer so as to follow the anvil 156 like FIG. 7(6) simply by rotating the motor 3 from the state of FIG. 7(5) to rotate the hammer 151 in a normal direction. Thus, by repeating this, fastening subject members, such as screws or bolts, capable of making fastening torque small, can be fastened at high speed.

In the impact tool 1 related to the present embodiment, a brushless DC motor is used as the motor 3. Therefore, by calculating the value of a current which flows into the motor 3 from the current detecting circuit 59 (refer to FIG. 5), detecting a state where the value of the current has become larger than a given value, and making the computing unit 51 stop the motor 3, a so-called clutch mechanism in which power transmission is interrupted after fastening to a given torque can be electronically realized. Accordingly, in the impact tool 1 related to the present embodiment, the clutch mechanism during the drill mode can also be realized, and the multi-use fastening tool which has a drill mode with no clutch, a drill mode with a clutch, and an impact mode can be realized by the striking mechanism with a simple construction.

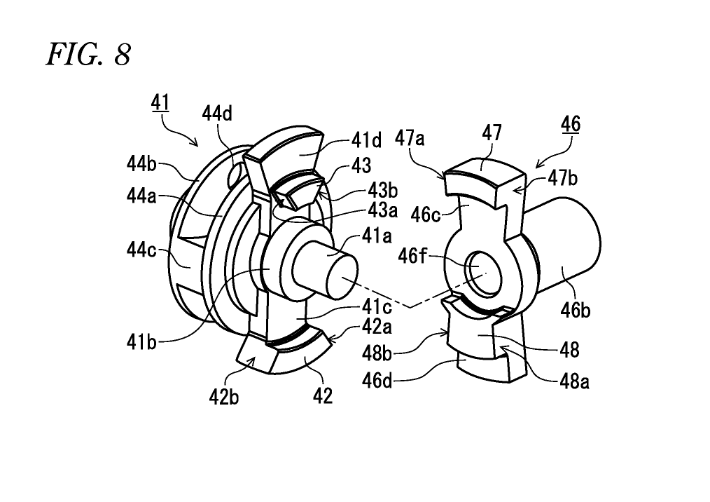

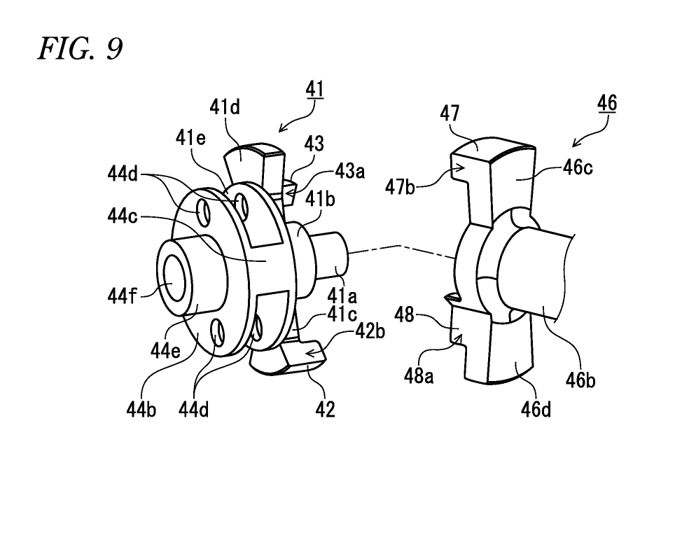

Next, the detailed structure of the striking mechanism 40 shown in FIGS. 1 and 2 will be described with reference to FIGS. 8 and 9. FIG. 8 illustrates the hammer 41 and the anvil 46 related to a first embodiment, in which the hammer 41 is seen obliquely from the front, and the anvil 46 is seen obliquely from the rear. FIG. 9 illustrates the hammer 41 and the anvil 46, in which the hammer 41 is seen obliquely from the rear, and the anvil 46 is seen obliquely from the front. The hammer 41 is formed with two blade portions 41c and 41d which protrude radially from the cylindrical main body portion 41b. Although the blade portions 41d and 41c are respectively formed with the protruding portions which protrude axially, this construction is different from the basic construction (second embodiment) shown in FIG. 6 in that a set of striking portions and a set of weight portions are formed in the blade portions 41d and 41c, respectively.

The outer peripheral portion of the blade portion 41c has the shape of a fan, and the protruding portion 42 protrudes axially forward from the outer peripheral portion. The fan-shaped portion and the protruding portion 42 function as both a striking portion (striking pawl) and a weight portion. The striking-side surfaces 42a and 42b are formed on both sides of the protruding portion 42 in a circumferential direction. Both the striking-side surfaces 42a and 42b are formed into flat surfaces, and a moderate angle is given so as to come into surface contact with a struck-side surface (which will be described later), of the anvil 46 well. Meanwhile, the blade portion 41d is formed to have a fan-shaped outer peripheral portion, and the mass of the fan-shaped portion increases due to the shape thereof. Asa result, the blade portion acts well as a weight portion. Further, a protruding portion 43 which protrudes axially forward from around the radial center of the blade portion 41d is formed. The protruding portion 43 acts as a striking portion (striking pawl), and striking-side surfaces 43a and 43b are formed on both sides of the protruding portion in the circumferential direction. Both the striking-side surfaces 43a and 43b are formed into flat surfaces, and a moderate angle is given in the circumferential direction so as to come into surface contact with a struck-side surface (which will be described later), of the anvil 46 well.

The fitting shaft 41a to be fitted into the fitting groove 46f of the anvil 46 is formed on the front side around the axial center of the main body portion 41b. Connecting portions 44c which connect two disc portions 44a and 44b at two places in the circumferential direction so as to function as a planetary carrier are formed on the rear side of the main body portion 41b. Through holes 44d are respectively formed at two places of the disc portions 44a and 44b in the circumferential direction, two planetary gears 21b (refer to FIG. 3) are arranged between the disc portions 44a and 44b, and the rotary shafts 21c (refer to FIG. 3) of the planetary gear 21b are mounted on the through holes 44d. A cylindrical portion 44e which extends with a cylinder shape is formed on the rear side of the disc portion 44b. The outer peripheral side of the cylindrical portion 44e is held inside the bearings 16b. The sun gear 21a (refer to FIG. 3) is arranged in a space 44f inside the cylindrical portion 44e. It is preferable not only in strength but also in weight to manufacture the hammer 41 and the anvil 46 which are shown in FIGS. 8 and 9 as a metallic integral structure.

The anvil 46 is formed with two blade portions 46c and 46d which protrude radially from the cylindrical main body portion 46b. A protruding portion 47 which protrudes axially rearward is formed around the outer periphery of the blade portion 46c. Struck-side surfaces 47a and 47b are formed on both sides of the protruding portion 47 in the circumferential direction. Meanwhile, a protruding portion 48 which protrudes axially rearward is formed around the radial center of the blade portion 46d. Struck-side surfaces 48a and 48b are formed on both sides of the protruding portion 48 in the circumferential direction. When the hammer 41 normally rotates (a rotation direction in which a screw, etc. is fastened), the striking-side surface 42a abuts on the struck-side surface 47a, and simultaneously, the striking-side surface 43a abuts on the struck-side surface 48a. When the hammer 41 reversely rotates (a rotation direction in which a screw, etc. is loosened), the striking-side surface 42b abuts on the struck-side surface 47b, and simultaneously, the striking-side surface 43b abuts on the struck-side surface 48b. The protruding portions 42, 43, 47, and 48 are formed to simultaneously abut at two places.

As such, according to the hammer 41 and the anvil 46 which are shown in FIGS. 8 and 9, since striking is performed at two places which are symmetrical with respect to the rotating axial center, the balance during striking is good, and the impact tool 1 is hardly shaken during striking. Since striking-side surfaces are respectively provided on both sides of a protruding portion in the circumferential direction, impact operation becomes possible not only during normal rotation but also during reverse rotation, an impact tool which is easy to use can be realized. Since the hammer 41 strikes the anvil 46 only in the circumferential direction, and the hammer 41 does not strike the anvil 46 axially forward, the tip tool does not unnecessarily push a fastening subject member, and there is an advantage when a wood screw, etc. is fastened into timber.

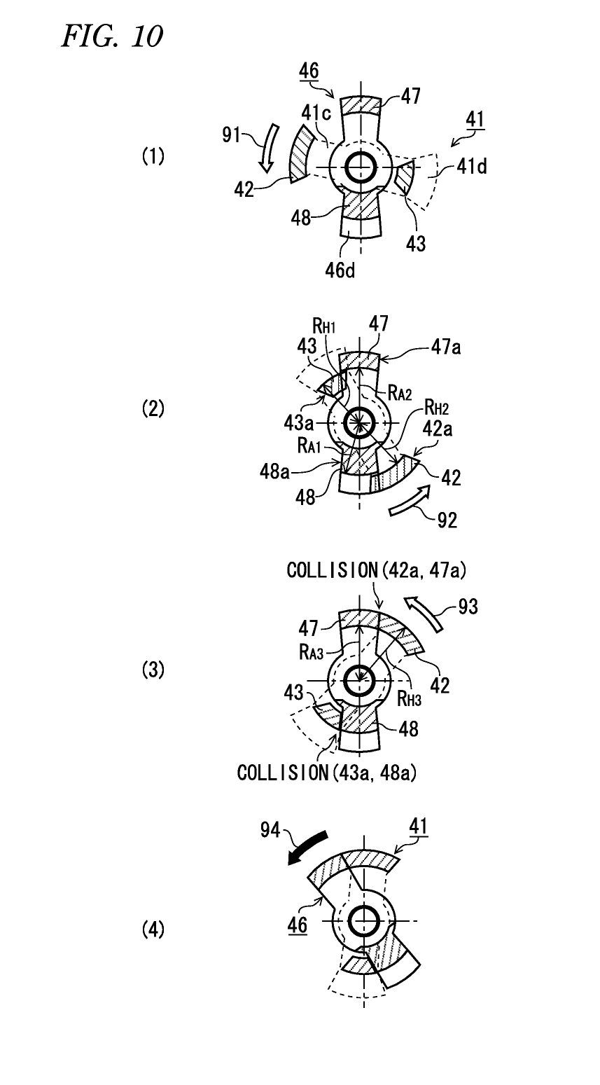

Next, the striking operation of the hammer 41 and the anvil 46 which are shown in FIGS. 8 and 9 will be described with reference to FIG. 10. The basic operation is the same as the operation described in FIG. 7, and the difference is that striking simultaneously performed in striking-side surfaces not at one place but at substantially-axisymmetric two places during striking. FIG. 10 illustrates a cross-section of a portion A-A of FIG. 3. FIG. 10 illustrates the positional relationship between the protruding portions 42 and 43 which protrude axially from the hammer 41, and the protruding portions 47 and 48 which protrude axially from the anvil 46. The rotation direction of the anvil 47 during the fastening operation (during normal rotation) is counterclockwise.

FIG. 10(1) is in a state where the hammer 41 reversely rotates to the maximum reverse rotation position with respect to the anvil 46 (equivalent to the state of FIG. 7(3)). From this state, the hammer 41 is accelerated in the direction of arrow 91 (in the normal direction) to strike the anvil 46. Then, like FIG. 10(2), the protruding portion 42 passes through the outer peripheral side of the protruding portion 48, and simultaneously the protruding portion 43 passes through the inner peripheral side of the protruding portion 47. In order to allow passage of both the protruding portions, the internal diameter R_{H2} of the protruding portion 42 is made greater than the external diameter R_{A1} of the protruding portion 48, and thus the protruding portions do not collide with each other. Similarly, the external diameter R_{H1} of the protruding portion 43 is made smaller than the internal diameter R_{A2} of the protruding portion 47, and thus both the protruding portions do not collide with each other. According to such positional relationship, the relative rotation angle of the hammer 41 and the anvil 46 can be made larger more than 180 degrees, the sufficient reverse rotation angle of the hammer 41 to the anvil 46 can be secured, and this reverse rotation angle can be located in the accelerating section before the hammer 41 strikes the anvil 46.

Next, when the hammer 41 normally rotates to the state of FIG. 10(3), the striking-side surface 42a of the protruding portion 42 collides with the struck-side surface 47a of the protruding portion 47. Simultaneously, the striking-side surface 43a of the protruding portion 43 collides with the striking-side surface 48a of the protruding portion 48. By causing collision at two places opposite to a rotation axis in this way, the striking which is well-balanced with respect to the anvil 46 can be performed. As a result of this striking, as shown in FIG. 10(4), the anvil 46 rotates in the direction of arrow 94, and fastening of a fastening subject member is performed by this rotation. The hammer 41 has the protruding portion 42 which is a solitary protrusion at a radial concentric position (a position above R_{H2} and below R_{H3}), and has the protruding portion 43 which is a third solitary protrusion at a concentric position (position below R_{H1}). The anvil 46 has the protruding portion 47 which is a solitary protrusion at a radial concentric position (a position above R_{A2} and below R_{A3}), and has the protruding portion 48 which is a solitary protrusion at a concentric position (position below R_{A1}).

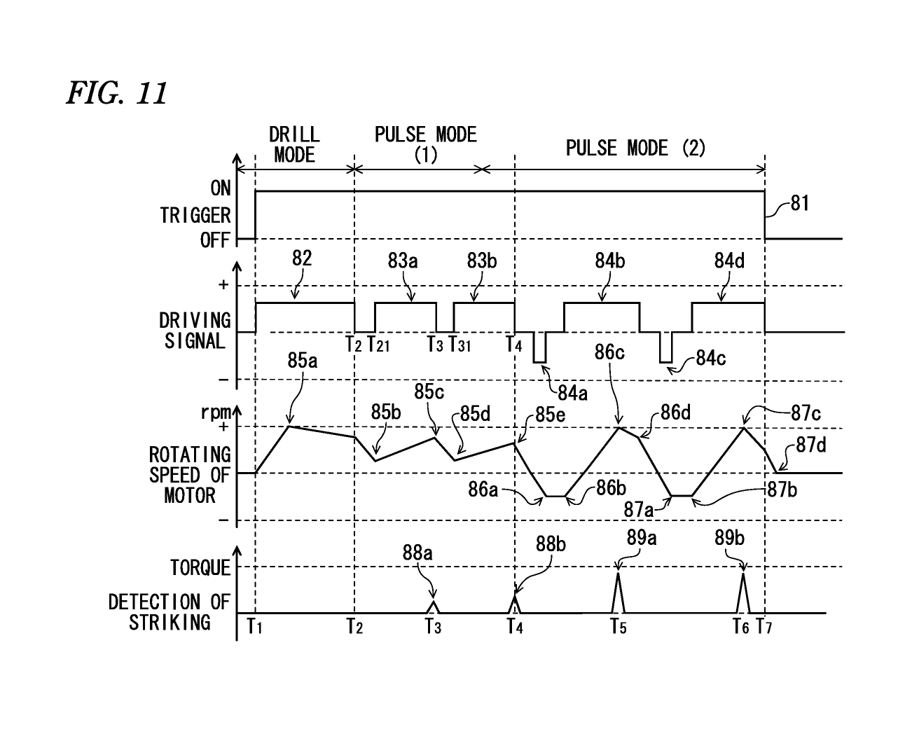

Next, the driving method of the impact tool 1 related to the present embodiment will be described. In the impact tool 1 related to the present embodiment, the anvil 46 and the hammer 41 are formed so as to be relatively rotatable at a rotation angle of less than 360 degrees. Since the hammer 41 cannot perform rotation of more than one rotation relative to the anvil 46, the control of the rotation is also unique. FIG. 11 illustrates a trigger signal during the operation of the impact tool 1, a driving signal of an inverter circuit, the rotating speed of the motor 3, and the striking state of the hammer 41 and the anvil 46. The horizontal axis is time in the respective graphs (timings of the respective graphs are matched).

In the impact tool 1 related to the present embodiment, in the case of the fastening operation in the impact mode, fastening is first performed at high speed in the drill mode, fastening is performed by switching to the impact mode (1) if it is detected that the required fastening torque becomes large, and fastening is performed by switching to the impact mode (2) if the required fastening torque becomes still larger. In the drill mode from time T₁ to time T₂ of FIG. 11, the control unit 51 controls the motor 3 based on a target rotation number. For this reason, the motor is accelerated until the motor 3 reaches the target rotation number shown by arrow 85a. Thereafter, the rotating speed of the motor 3 with a large fastening reaction force from the tip tool attached to the anvil 46 decreases gradually as shown by arrow 85b. Thus, decrease of the rotation speed is detected by the value of a current to be supplied to the motor 3, and switching to the rotation driving mode by the pulse mode (1) is performed at time T₂.

The pulse mode (1) is a mode in which the motor 3 is not continuously driven but intermittently driven, and is driven in pulses so that “pause→normal rotation driving” is repeated multiple times. The expression “driven in pulses” means controlling driving so as to pulsate a gate signal to be applied to the inverter circuit 52, pulsate a driving current to be supplied to the motor 3, and thereby pulsate the rotation number or output torque of the motor 3. This pulsation is generated by repeating ON/OFF of a driving current with a large period (for example, about several tens of hertz to a hundred and several tens of hertz), such as ON (driving) of the driving current to be supplied to the motor from time T₂ to time T₂₁ (pause), ON (driving) of the driving current of the motor from time T₂₁ to time T₃, OFF (pause) of the driving current from time T₃ to time T₃₁, and ON of the driving current from time T₃₁ to time T₄. Although PWM control is performed for the control of the rotation number of the motor 3 in the ON state of the driving current, the period to be pulsated is sufficiently small compared with the period (usually several kilohertz) of duty ratio control.

In the example of FIG. 11, after supply of the driving current to the motor 3 for a given time period from T₂ is paused, and the rotating speed of the motor 3 decreases to arrow 85b, the control unit 51 (refer to FIG. 5) sends a driving signal 83a to the control signal output circuit 53, thereby supplying a pulsating driving current (driving pulse) to the motor 3 to accelerate the motor 3. This control during acceleration does not necessarily mean driving at a duty ratio of 100% but means control at a duty ratio of less than 100%. Next, striking power is given as shown by arrow 88a as the hammer 41 collides with the anvil 46 strongly at arrow 85c. When striking power is given, the supply of a driving current to the motor 3 for a given time period is paused, and the rotating speed of the motor decreases again as shown by arrow 85b. Thereafter, the control unit 51 sends a driving signal 83b to the control signal output circuit 53, thereby accelerating the motor 3. Then, striking power is given as shown by arrow 88b as the hammer 41 collides with the anvil 46 strongly at arrow 85e. In the pulse mode (1), the above-described intermittent driving of repeating “pause→normal rotation driving” of the motor 3 is repeated one time or multiple times. If it is detected that further higher fastening torque is required, switching to the rotation driving mode by the pulse mode (2) is performed. Whether or not further higher fastening torque is required can be determined using, for example, the rotation number (before or after arrow 85e) of the motor 3 when the striking power shown by arrow 88b is given.

Although the pulse mode (2) is a mode in which the motor 3 is intermittently driven, and is driven in pulses similarly to the pulse mode (1), the motor is driven so that “pause→reverse rotation driving→pause (stop)→normal rotation driving” is repeated plural times. That is, in the pulse mode (2), in order to add not only the normal rotation driving but also the reverse rotation driving of the motor 3, the hammer 41 is accelerated in the normal rotation direction so as to strongly collide with the anvil 46 after the hammer 41 is reversely rotated by a sufficient angular relation with respect to the anvil 46. By driving the hammer 41 in this way, strong fastening torque is generated in the anvil 46.

In the example of FIG. 11, when switching to the pulse mode (2) is performed at time T₄, driving of the motor 3 is temporarily paused, and then, the motor 3 is reversely rotated by sending a driving signal 84a in a negative direction to the control signal output circuit 53. When normal rotation or reverse rotation is performed, this normal rotation or reverse rotation is realized by switching the signal pattern of each driving signal (ON/OFF signal) to be output to each of the switching elements Q1 to Q6 from the control signal output circuit 53. If the motor 3 is reversely rotated by a given rotation angle, driving of the motor 3 is temporarily paused to start normal rotation driving. For this reason, a driving signal 84b in a positive direction is sent to the control signal output circuit 53. In the rotational driving using the inverter circuit 52, a driving signal is not switched to the plus side or minus side. However, a driving signal is classified into the + direction and − direction and is schematically expressed in FIG. 11 so that whether the motor is rotationally driven in any direction can be easily understood.

The hammer 41 collides with the anvil 46 at a time when the rotating speed of the motor 3 reaches a maximum speed (arrow 86c). Due to this collision, significant large fastening torque 89a is generated compared to fastening torques (88a, 88b) to be generated in the pulse mode (1). When collision is performed in this way, the rotation number of the motor 3 decreases so as to reach arrow 86d from arrow 86c. In addition, the control of stopping a driving signal to the motor 3 at the moment when the collision shown by arrow 89a is detected may be performed. In that case, if a fastening subject is a bolt, a nut, etc., the recoil transmitted to the user's hand after striking is little. By applying a driving current to the motor 3 as in the present embodiment even after collision, the reaction force to the user is small as compared to the drill mode, and is suitable for the operation in a middle load state. Thus, the fastening speed can be increased, and power consumption can be reduced as compared to a strong pulse mode. Thereafter, similarly, fastening with strong fastening torque is performed by repeating “pause→reverse rotation driving→pause (stop)→normal rotation driving” by a given number of times, and the motor 3 is stopped to complete the fastening operation as the user releases a trigger operation at time T₇. In addition to the release of the trigger operation by the user, the motor 3 may be stopped when the computing unit 51 determines that fastening with set fastening torque is completed based on the output of the striking impact detecting sensor 56 (refer to FIG. 5).

As described above, in the present embodiment, rotational driving is performed in the drill mode in an initial stage of fastening where only small fastening torque is required, fastening is performed in the impact mode (1) by intermittent driving of only normal rotation as the fastening torque becomes large, and fastening is strongly performed in the impact mode (2) by intermittent driving by the normal rotation and reverse rotation of the motor 3, in the final stage of fastening. In addition, driving may be performed using the impact mode (1) and the impact mode (2). The control of proceeding directly to the impact mode (2) from the drill mode without providing the impact mode (1) is also possible. Since the normal rotation and reverse rotation of the motor are alternately performed in the impact mode (2), fastening speed becomes significantly slower than that in the drill mode or impact mode (1). When the fastening speed becomes abruptly slow in this way, the sense of discomfort when transiting to the striking operation becomes large compared to an impact tool which has a conventional rotation striking mechanism. Thus, in the shifting to the impact mode (2) from the drill mode, an operation feeling becomes a natural feeling by interposing the impact mode (1) therebetween. For example, by performing fastening in the drill mode or impact mode (1) as much as possible, fastening operation time can be shortened.

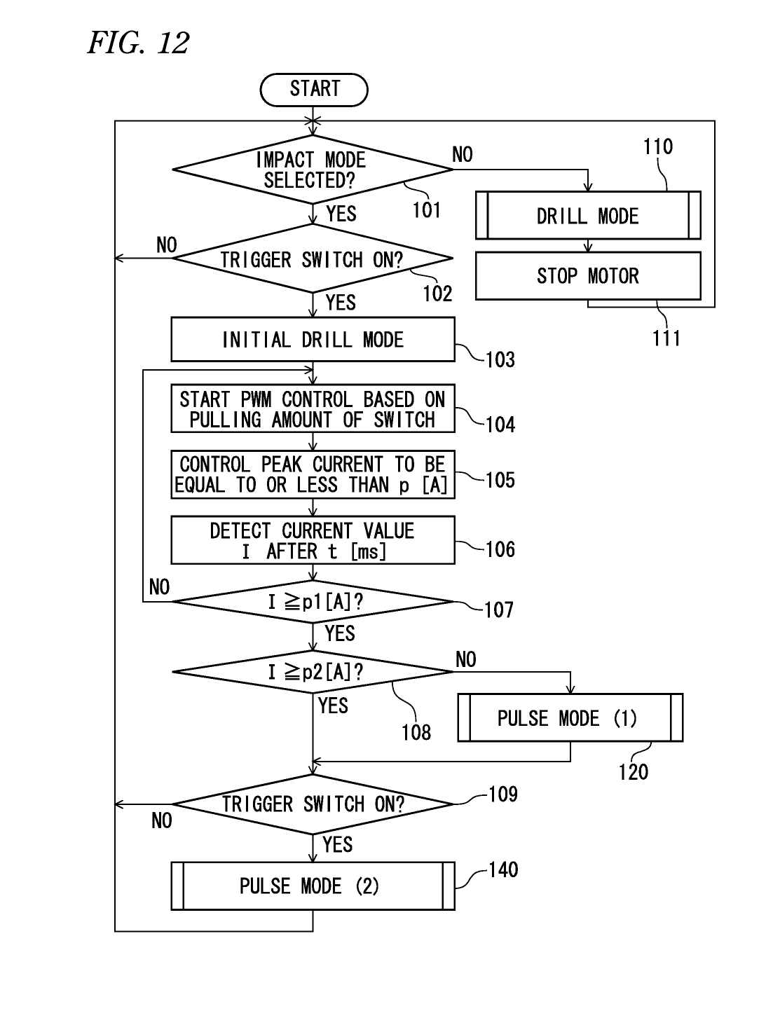

Next, the control procedure of the impact tool 1 related to the embodiment will be described with reference to FIG. 12 to FIG. 16. FIG. 12 illustrates the control procedure of the impact tool 1 related to the embodiment. The impact tool 1 determines whether or not the impact mode is selected using the toggle switch 32 (refer to FIG. 2) prior to start of the operation by the user (Step 101). If the impact mode is selected, the process proceeds to Step 102, and if the impact mode is not selected, that is, in the case of a normal drill mode, the process proceeds to Step 110.

In the impact mode, the computing unit 51 determines whether or not the trigger switch 8 is turned on. If the trigger switch is turned on (the trigger operating portion 8a is pulled), as shown in FIG. 11, the motor 3 is started by the drill mode (Step 103), and the PWM control of the inverter circuit 52 is started according to the pulling amount of the trigger operating portion 8a (Step 104). Then, the rotation of the motor 3 is accelerated while performing a control so that a peak current to be supplied to the motor 3 does not exceed an upper limit p. Next, the value I of a current to be supplied to the motor 3 after t milliseconds have elapsed after starting is detected using the output of the current detecting circuit 59 (refer to FIG. 5). If the detected current value I does not exceed p1 ampere, the process returns to Step 104, and if the current value has exceeded p1 ampere, the process proceeds to Step 108 (Step 107). Next, it is determined whether or not the detected current value I exceeds p2 ampere (Step 108).

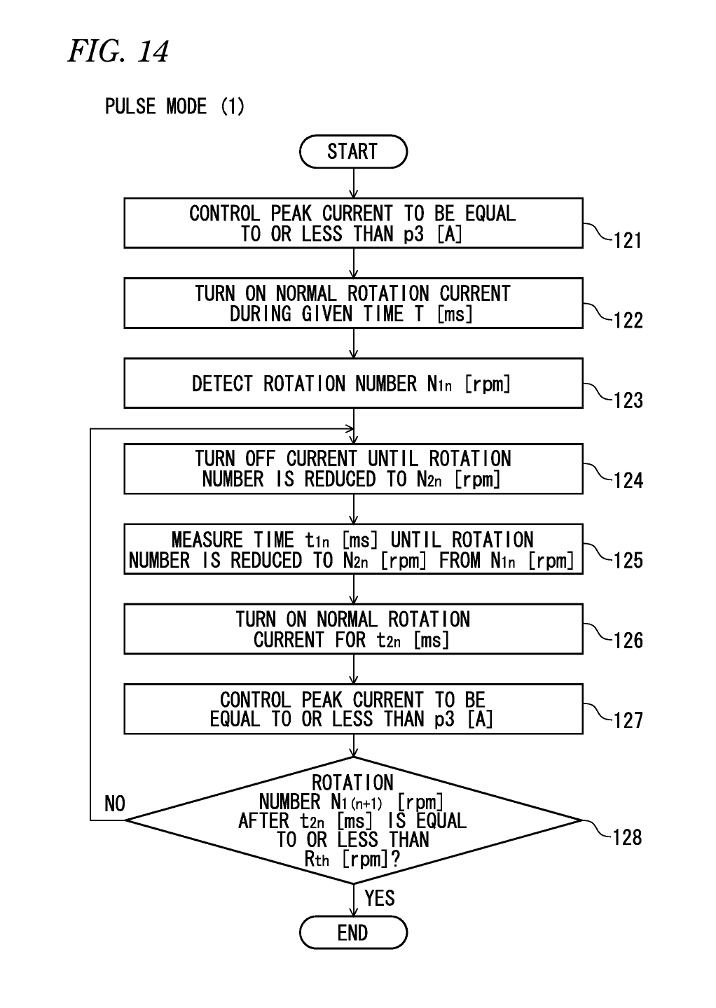

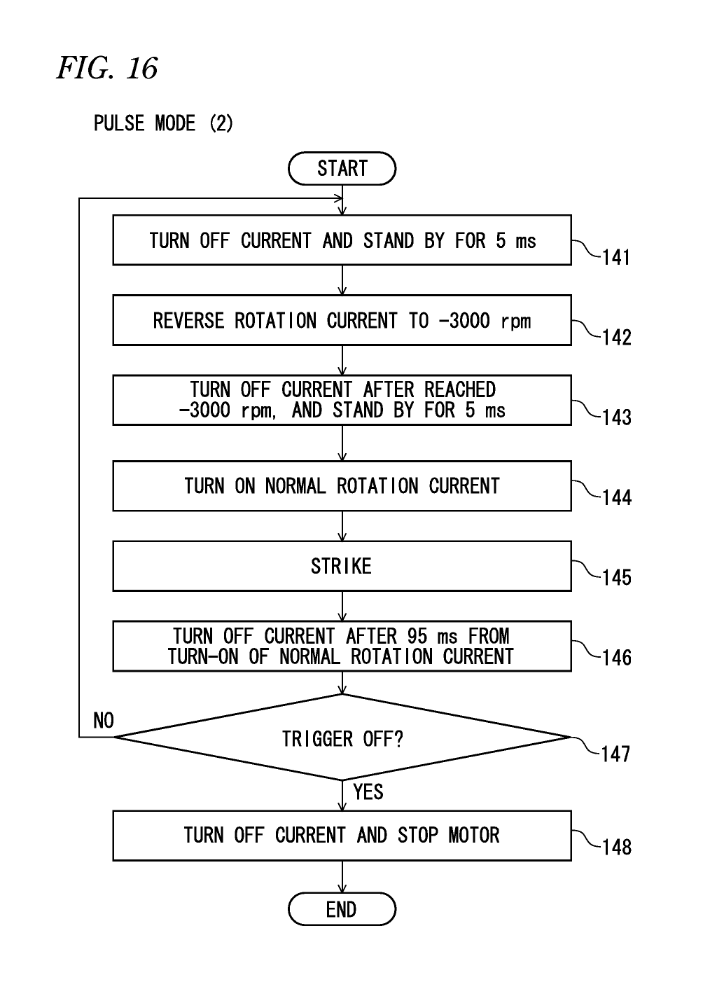

If the detected current value I does not exceed p2 [A] in Step 108, that is, if the relationship of p1<I<p2 is satisfied, the process proceeds to Step 109 (Step 120) after the procedure of the pulse mode (1) shown in FIG. 14 is executed. Then, if the detected current value I exceeds p2 [A], the process proceeds directly to Step 109, without executing the procedure of the pulse mode (1). In Step 109, it is determined whether or not the trigger switch 8 is set to ON. If the trigger switch is turned off, the processing returns to Step 101. If the ON state is continued, the processing returns to Step 101 after the procedure of the pulse mode (2) shown in FIG. 16 is executed.

If the drill mode is selected in Step 101, the drill mode 110 is executed, but the control of the drill mode is the same as the control of Steps 102 to 107. Then, by detecting a control current in an electronic clutch or an overcurrent state immediately before the motor 3 is locked as p1 of Step 107, thereby stopping the motor 3 (Step 111), the drill mode is ended, and the processing returns to Step 101.

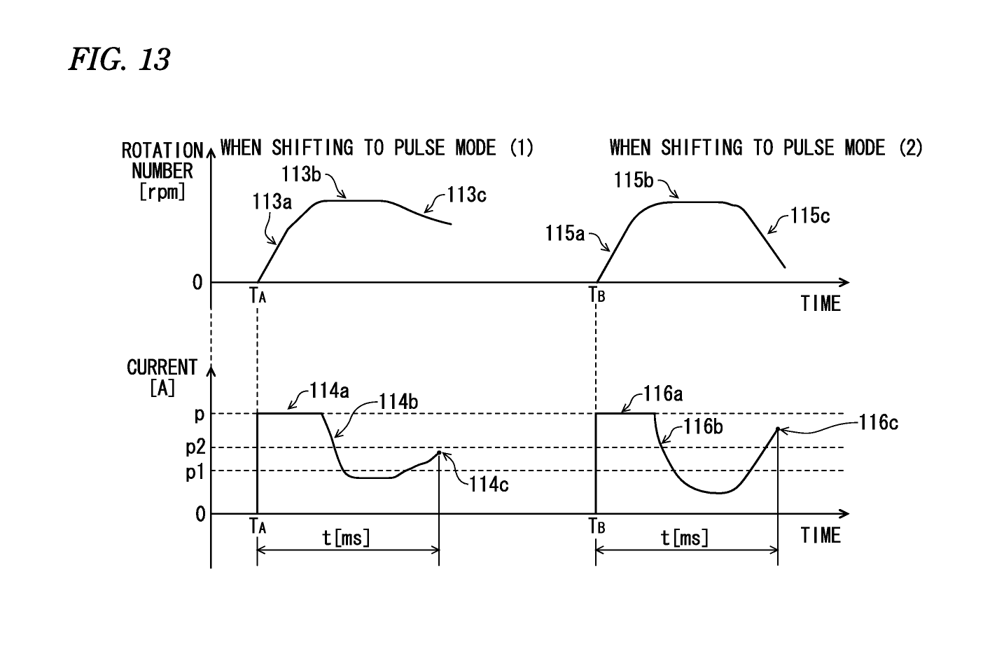

The determination procedure of the mode shifting in Steps 107 and 108 will be described with reference to FIG. 13. An upper graph shows the relationship between elapsed time and the rotation number of the motor 3, a lower graph shows the relationship between a current value to be supplied to the motor 3, and time, and the time axes of the upper and lower graphs are made the same. In the left graph, when the trigger switch is pulled at time T_{A} (equivalent to Step 102 of FIG. 12), the motor 3 is started and accelerated as shown by arrow 113a. During this acceleration, a constant current control in a state where the maximum current value p is limited as shown by arrow 114a is performed. When the rotation number of the motor 3 reaches a given rotation number (arrow 113b), a current during acceleration becomes a usual current as shown by arrow 114b. Therefore, the current value decreases. Thereafter, when the reaction force received from a fastening member increases as fastening of a screw, a bolt, etc. proceeds, the rotation number of the motor 3 decreases gradually as shown by arrow 113c, and the value of a current to be supplied to the motor 3 increases. Then, the current value is determined after t milliseconds have elapsed from the starting of the motor 3. If the relationship of p1<I<p2 is satisfied as shown by arrow 114c, the process shifts to the control of the pulse mode (1) which will be described later, as shown in Step 120.

In the right graph, when the trigger switch is pulled at time T_{B} (equivalent to Step 102 of FIG. 12), the motor 3 is started and accelerated as shown by arrow 115a. During this acceleration, a constant current control in a state where the maximum current value p is limited as shown by arrow 116a is performed. When the rotation number of the motor 3 reaches a given rotation number (arrow 115b), a current during acceleration becomes a usual current as shown by arrow 116b. Therefore, the current value decreases. Thereafter, when the reaction force received from a fastening member increases as fastening of a screw, a bolt, etc. proceeds, the rotation number of the motor 3 decreases gradually as shown by arrow 115c, and the value of a current to be supplied to the motor 3 increases. In this example, the reaction force received from a fastening member increased rapidly. Therefore, as shown by arrow 116c, decrease of the rotation number of the motor 3 is large, and the rising degree of the current value is large. Then, since the current value after t milliseconds have elapsed from the starting of the motor 3 satisfies the relationship of p2<I as shown by arrow 116c, the process shifts to the control of the pulse mode (2) shown in FIG. 16 as shown in Step 140.

Usually, in the fastening operation of a screw, a bolt, etc., required that fastening torque is not often constant due to variation in the machining accuracy of a screw or a bolt, the state of a fastening subject member, variation in materials, such as knots, grain, etc. of timber. Therefore, fastening may be performed at a stroke until immediately before completion of the fastening only by the drill mode. In such a case, when fastening in the impact mode (1) is skipped, and shifting to the fastening by the drill mode (2) with a higher fastening torque is made, the fastening operation can be efficiently completed in a short time.

Next, the control procedure of the impact tool in the pulse mode (1) will be described with reference to FIG. 14. If the process has shifted to the pulse mode (1), the peak current is first limited to equal to or less than p3 ampere (Step 121) after a given pause period, and the motor 3 is rotated by supplying a normal rotation current to the motor 3 during a given time, i.e., T milliseconds (Step 122). Next, the rotation number N₁ₙ [rpm] of the motor 3 after time T milliseconds have elapsed is detected (n=1, 2, . . . ) (Step 123). Next, a driving current to be supplied to the motor 3 is turned off, and the time t₁ₙ which is required until the rotation number of the motor 3 is lowered to N₂ₙ (=N₁ₙ/2) from N₁ₙ is measured. Next, t₂ₙ is obtained from t₂ₙ=X−t₁ₙ, a normal rotation current is applied to the motor 3 during a period of this t₂ₙ (Step 126), and the peak current is suppressed to equal to or less than p3 ampere, thereby accelerating the motor 3. Next, it is determined whether or not the rotation number N₁₍ₙ₊₁₎ of the motor 3 is equal to or less than a threshold rotation number Rₜₕ for shifting to the pulse mode (2) after the elapse of the time t₂ₙ. If the rotation number of the motor is equal to or less than Rₜₕ, the processing of the pulse mode (1) is ended, the processing returns to Step 120 of FIG. 12, and if the rotation number of the motor is equal to or more than Rₜₕ, the processing returns to Step 124 (Step 128).

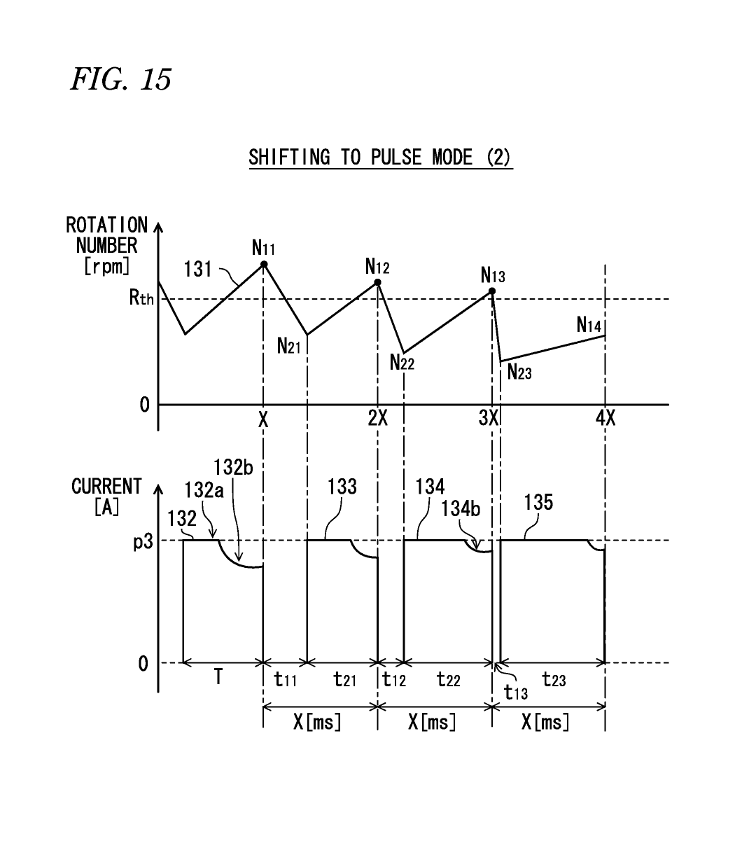

FIG. 15 illustrates the relationship between the rotation number of the motor 3 and elapsed time and the relationship between a current to be supplied to the motor 3 and elapsed time while the control procedure illustrated in FIG. 14 is executed. A driving current 132 is first supplied to the motor 3 by time T. Since the driving current limits the peak current to equal to or less than p3 ampere, the current during acceleration is limited as shown by arrow 132a, and thereafter, the current value decreases as shown by arrow 132b as the rotation number of the motor 3 increases. At time T₁, when it is measured that the rotation number of the motor 3 has reached N₁₁, the rotation number N₂₁ which starts the rotation of the motor 3 from N₂₁=N₁₁/2 is calculated by calculation. The rotation number N₁₁ is, for example, 10,000 rpm. When the rotation number of the motor 3 decreases to N₂₁, a driving current 133 is supplied, and the motor 3 is accelerated again. Time t₂ₙ during which the driving current 133 is applied is determined by t₂ₙ=X−t₁ₙ. Similarly, although the same control is performed at times 2× and 3×, the rising degree of the rotation number of the motor 3 decreases as the fastening reaction force becomes large, and the rotation number N₁₄ will become equal to or less than the threshold rotation value Rₜₕ at time 4×. At this time, the processing of the pulse mode (1) is ended, and the process shifts to the processing of the pulse mode (2).

Next, the control procedure of the impact tool in the pulse mode (2) will be described with reference to FIG. 16. First, a driving current to be supplied to the motor 3 is turned off, and standby is performed for 5 milliseconds (Step 141). Next, a reverse rotation current is supplied to the motor 3 so as to rotate the motor at −3000 rpm (Step 142). The ‘minus’ means that the motor 3 is rotated in a direction reverse to the rotation direction under operation at 3000 rpm. Next, if the rotation number of the motor 3 has reached −3000 rpm, a current to be supplied to the motor 3 is turned off, and standby is performed for 5 milliseconds (Step 143). The reason why standby is performed for 5 milliseconds is because there is a possibility that the main body of the impact tool may be shaken when the motor 3 is reversely rotated suddenly in a reverse direction. Further, this is also because there is no consumption of electric power during this standby, and thus, energy saving can be achieved. Next, a normal rotation current is turned on in order to rotate the motor 3 in the normal rotation direction (Step 144). A current to be supplied to the motor 3 is turned off 95 milliseconds after the normal rotation current is turned on. However, strong fastening torque is generated in the tip tool as the hammer 41 collides with (strikes) the anvil 46 before this current is turned off, (Step 145). Thereafter, it is detected whether or not the ON state of the trigger switch is maintained. If the trigger switch is in an OFF state, the rotation of a motor 3 is stopped, the processing of the pulse mode (2) is ended, and the processing returns to Step 140 of FIG. 12 (Steps 147 and 148). In Step 147, if the trigger switch 8 is in an ON state, the processing returns to Step 141 (Step 147).

As described above, according to the present embodiment, a fastening member can be efficiently fastened by performing continuous rotation, intermittent rotation only in the normal direction, and intermittent rotation in the normal direction and in the reverse direction for the motor using the hammer and the anvil between which the relative rotation angle is less than one rotation. Further, since the hammer and the anvil can be made into a simple structure, miniaturization and cost reduction of the impact tool can be realized.

Although the invention has been described hitherto based on the shown embodiments, the invention is not limited to the above-described embodiments and can be variously changed without departing from the spirit or scope thereof. For example, a brushless DC motor is exemplified as the motor in the present embodiment, the invention is not limited thereto, and other kinds of motor which can be driven in the normal direction and in the reverse direction may be used.

Further, the shape of the anvil and the hammer is arbitrary. It is only necessary to provide a structure in which the anvil and the hammer cannot continuously rotate relative to each other (cannot rotate while riding over each other), secure a given relative rotation angle of less than 360 degrees, and form a striking-side surface and a struck-side surface. For example, the protruding portion of the hammer and the anvil may be constructed so as not to protrude axially but to protrude in the circumferential direction. Further, since the protruding portions of the hammer and the anvil are not necessarily only protruding portions which become convex to the outside, and have only to be able to form a striking-side surface and a struck-side surface in a given shape, the protruding portions may be protruding portions (that is, recesses) which protrude inside the hammer or the anvil. The striking-side surface and the struck-side surface are not necessarily limited to flat surfaces, and may be a curved shape or other shapes which form a striking-side surface or a struck-side surface well.

This application claims priority from Japanese Patent Application No. 2009-177115 filed on Jul. 29, 2009, the entire contents of which are incorporated herein by reference.

### INDUSTRIAL APPLICABILITY

According to an aspect of the invention, there is provided an impact tool in which an impact mechanism is realized by a hammer and an anvil with a simple mechanism.

According to another aspect of the invention, there is provided an impact tool which can drive a hammer and an anvil between which the relative rotation angle is less than 360 degrees, thereby performing a fastening operation, by devising a driving method of a motor.

According to still another aspect of the invention, there is provided a multi-use impact tool which can switch and be used in a drill mode and impact mode.

1. An impact tool comprising:
a motor; and
a hammer that is connected to the motor and that has a striking-side surface; and
an anvil that is journalled to be rotatable with respect to the hammer, that has a struck-side surface and that provides a striking power to a tip tool,
wherein the motor is drivable in:
a first driving mode in which the motor is continuously driven in a normal rotation;
a second driving mode in which the motor is intermittently driven only in the normal rotation; and
a third driving mode in which the motor is intermittently driven in the normal rotation and in a reverse rotation.

2. The impact tool of claim 1,
wherein the impact tool is operable in:
a drill mode in which the motor is driven in the first mode; and
an impact mode in which the motor is driven in at least two of the first to third driving modes while switching therebetween.

3. The impact tool of claim 2, further comprising:
an inverter circuit that supplies a given driving current to the motor; and
a control unit that controls the inverter circuit to thereby control a rotation direction and a rotating speed of the motor so that the first to third driving modes are performed.

4. The impact tool of claim 3,
wherein the second driving mode and the third driving mode are performed by a pulse control of the inverter circuit.

5. The impact tool of claim 4,
wherein, in the impact mode, the motor is driven in the first driving mode when a load is light, and the motor is driven in the second driving mode when the load becomes heavy.

6. The impact tool of claim 5,
wherein, in the impact mode, the motor is driven in the third mode when the load further becomes heavier in a state where the motor is driven in the second mode.

7. The impact tool of claim 6,
wherein the control unit shifts the motor between the first to third driving modes based on:
a value of a current flowing into the motor;
a change in the rotating speed of the motor; or
a value of an impact torque generated at an output shaft of the anvil.

8. The impact tool of claim 7,
wherein, in the third driving mode, the motor is reversely rotated until reaching a given reverse rotating speed.

9. The impact tool of claim 1, further comprising:
a current detecting circuit that detects a current flowing into the motor,
wherein, in the drill mode, the control unit stops the motor when a value of the detected current becomes equal to or higher than a given threshold value.

10. The impact tool of claim 9, further comprising:
a switching dial that allows the user:
to switch between the drill mode and the impact mode and
to set, within the drill mode, plural stages of torque values for stopping a rotation of the motor.

11. An impact tool comprising:
a motor; and
a hammer that is connected to the motor and that has a striking-side surface; and
an anvil that is journalled to be rotatable with respect to the hammer, that has a struck-side surface and that provides a striking power to a tip tool,
wherein the motor is drivable in:
a first intermittent driving mode; and
a second intermittent driving mode different from the first intermittent driving mode.

12. The impact tool of claim 11,
wherein, in the first intermittent driving mode, the motor is intermittently rotated only in a normal rotation,
wherein, in the second intermittent driving mode, the motor is intermittently rotated in the normal rotation and in a reverse rotation, and
wherein the motor is switchable from the first intermittent driving mode to the second intermittent driving mode.

13. The impact tool of claim 11,
wherein the motor is switchable from the first intermittent driving mode to the second intermittent driving mode during one fastening operation.

14. The impact tool of claim 11,
wherein the striking power of the hammer to the anvil in the first intermittent driving mode is smaller than the striking power of the hammer to the anvil in the second intermittent driving mode.

15. The impact tool of claim 11,
wherein a striking speed of the hammer in the first intermittent driving mode is smaller than the striking speed of the hammer in the second intermittent driving mode.

16. The impact tool of claim 11,
wherein a rotating speed of the hammer in the first intermittent driving mode is smaller than the rotating speed of the hammer in the second intermittent driving mode.

17. The impact tool of claim 11, further comprising:
an inverter circuit that supplies a given driving current to the motor; and
a control unit that controls so that a supply time, an amplitude, or effective value of a driving pulse to be supplied to the inverter circuit for the normal ration of the motor in the first intermittent driving mode is smaller than these in the second intermittent driving mode.
